(19) United States
(12) Patent Application Publication
(10) Pub. No.: US 2017/0197390 A1
(43) Pub. Date: Jul. 13, 2017

(54) GAS BARRIER FILM, ELECTRONIC DEVICE, AND MANUFACTURING METHOD OF GAS BARRIER FILM

(71) Applicant: FUJIFILM Corporation, Tokyo (JP)

(72) Inventor: Takashi YAKUSHIJI, Minami-ashigara-shi (JP)

(73) Assignee: FUJIFILM Corporation, Tokyo (JP)

(21) Appl. No.: 15/468,271

(22) Filed: Mar. 24, 2017

Related U.S. Application Data
(63) Continuation of application No. PCT/JP2015/076283, filed on Sep. 16, 2015.

(30) Foreign Application Priority Data
Sep. 29, 2014 (JP) 2014-199268

(51) Int. Cl. B32B 27/06; B32B 37/14

(52) U.S. Cl. CPC B32B 27/06; B32B 37/14; B32B 2457/20; B32B 2307/7242; B32B 2309/105

(57) ABSTRACT

In a gas barrier film having a laminated structure of an organic layer and an inorganic layer, an identification mark is formed on a forming surface of the organic layer. Accordingly, the gas barrier film having the laminated structure of the organic layer and the inorganic layer includes the identification mark which is used for preparing an electronic device, or the like, and can prevent a breakage of the inorganic layer due to the identification mark.

### CROSS-REFERENCE TO RELATED APPLICATIONS

This application is a Continuation of PCT International Application No. PCT/JP2015/076283 filed on Sep. 16, 2015, which claims priority under 35 U.S.C. §119(a) to Japanese Patent Application No. 2014-199268 filed on Sep. 29, 2014. The above application is hereby expressly incorporated by reference, in its entirety, into the present application.

### BACKGROUND OF THE INVENTION

1. Field of the Invention

The present invention relates to a gas barrier film which is used for manufacturing an electronic device, or the like, an electronic device using the gas barrier film, and a manufacturing method of the gas barrier film.

2. Description of the Related Art

A gas barrier film is used in various electronic devices including an element which is degraded by moisture, such as a display device, for example, an organic EL display, a semiconductor device, and a solar battery, an infusion bag storing a medical agent which is altered by moisture or oxygen, and similarly, a tube or a packaging bag storing food which is degraded by moisture or oxygen, and the like.

The gas barrier film has a configuration in which a resin film such as a polyethylene terephthalate (PET) film is used as a support, and a gas barrier layer formed of a material having barrier properties is formed on the resin film, as an example.

For example, in JP2009-102048A, a laminated gas barrier film including a printing layer on a support, an adhesive layer on the printing layer, a gas barrier layer on the adhesive layer, and a sealant layer on the gas barrier layer, is described as a gas barrier film for a packaging bag (a laminated film for a packaging bag).

In addition, in JP2009-102048A, it is described that scar processing is performed with respect to the support in order to make the openability of the packaging bag excellent. Further, in JP2009-102048A it is also described that an identification mark (an eye mark) is formed on the printing layer in order to position a forming position of the scar processing.

In such a gas barrier film, a gas barrier film having an organic and inorganic laminated structure in which an organic layer which becomes an undercoat layer and an inorganic layer formed of an inorganic compound which is formed on the organic layer are alternately formed, is known as a configuration in which higher gas barrier properties can be obtained. The gas barrier properties of the gas barrier film are mainly exhibited by the inorganic layer.

The gas barrier film having the organic and inorganic laminated structure includes the organic layer which becomes the undercoat layer, and thus, the inorganic layer exhibiting gas barrier properties can be properly formed as a continuous film. Therefore, the gas barrier film has extremely high gas barrier properties. In addition, it is also known that the gas barrier film has a plurality of laminated structures of the organic layer and the inorganic layer, and thus, higher gas barrier properties can be obtained.

For example, in JP2007-30387A, a gas barrier film (a barrier film substrate) in which an alternate laminate of an organic layer and an inorganic layer formed of at least one organic layer and at least two inorganic layers is formed on a front surface of a plastic film, the organic layer contains one or more organic compounds selected from polyurea, polyurethane, polyamide, polyimide, polyacrylate, and polymethacrylate, and greater than or equal to 99.5 mass % of the organic compound is a solid at 25° C., is described as the gas barrier film having the organic and inorganic laminated structure.

Here, an electronic device such as an organic electroluminescence device (an organic EL device) or a solar battery is generally formed on a glass substrate.

In contrast, recently, a resin film has started to be used as a substrate since an electronic device can have excellent lightweight properties or excellent flexibility. By using the resin film as the substrate of the electronic device, it is possible to manufacture the electronic device in a roll to roll manner, and thus, using the resin film is also advantageous from the viewpoint of a production efficiency or production costs.

Here, the organic EL device or the solar battery, in general, is sensitive to moisture, and thus, is easily degraded by the moisture. For this reason, it is also considered that the organic EL device or the like is prepared by using the gas barrier film as the substrate, and thus, the permeation of the moisture is prevented.

For example, in JP2007-30387A described above, it is described that the organic EL device is prepared by using the gas barrier film having the organic and inorganic laminated structure as the substrate.

### SUMMARY OF THE INVENTION

In order to prepare an electronic device by using the gas barrier film having the organic and inorganic laminated structure as the substrate, it is necessary to form the identification mark as described in JP2009-102048A to perform positioning of a forming member of an element, or the like.

However, in the gas barrier film having the organic and inorganic laminated structure, the inorganic layer which mainly exhibits the gas barrier properties is hard and brittle. For this reason, a stress is locally concentrated on the inorganic layer according to the forming position of the identification mark, and thus, the inorganic layer is damaged, and gas bather performance considerably decreases.

In addition, printing layer on which the identification mark can be formed as with the gas barrier film for a packaging bag described in JP2009-102048A, does not exist in the gas barrier film which is used as the substrate of the electronic device.

An object of the present invention is to solve such problems of the related art and to provide a gas barrier film having an identification mark which is preferably used for manufacturing an electronic device such as an organic EL device, or the like, in which high gas barrier properties are obtained by an organic and inorganic laminated structure, and an inorganic layer can also be prevented from being damaged due to the identification mark, an electronic device using the gas barrier film, and a manufacturing method of the gas barrier film.

In order to attain such an object, the gas barrier film of the present invention provides a gas barrier film, comprising: a support; an organic and inorganic laminated structure which is formed on the support and has at least one organic layer and at least one inorganic layer, and in which the organic layer and the inorganic layer are alternately laminated; and an identification mark formed on a forming surface of the at least one organic layer.

In such a gas barrier film of the present invention, it is preferable that the identification mark and the organic layer are formed on a front surface of the support.

In addition, it is preferable that an organic layer formed on a fainting surface of the identification mark has a flat front surface by absorbing irregularity due to the identification mark.

In addition, it is preferable that the organic layer formed on the forming surface of the identification mark has a thickness two or more times a thickness of the identification mark.

Further, it is preferable that the thickness of the identification mark is less than or equal to 200 nm, and the thickness of the organic layer formed on the forming surface of the identification mark is greater than or equal to 500 nm.

In addition, the electronic device of the present invention provides an electronic device, comprising: an electronic element constituting the electronic device, which is formed on the gas barrier film of the present invention.

In addition, the manufacturing method of the gas barrier film of the present invention provides a manufacturing method of a gas barrier film, comprising: forming an organic and inorganic laminated structure on a support, in which at least one organic layer and at least one inorganic layer are provided, and the organic layer and the inorganic layer are alternately laminated; and forming an identification mark on a forming surface of the organic layer before forming the at least one organic layer.

In such a manufacturing method of a gas barrier film of the present invention, it is preferable that the identification mark and the organic layer are formed on the support.

In addition, it is preferable that the organic layer is formed by a coating method using a composition containing a polymerizable compound.

According to the present invention, in the gas barrier film having the organic and inorganic laminated structure in which high gas barrier properties are exhibited, the identification mark is formed, and the identification mark is covered with the organic layer, and thus, it is possible to prevent the inorganic layer from being damaged by a local concentration of a stress on the inorganic layer due to the identification mark.

Accordingly, according to the present invention, it is possible to manufacture the electronic device such as an organic EL device by using the gas barrier film having high gas barrier properties in which the identification mark is formed.

### BRIEF DESCRIPTION OF THE DRAWINGS

FIG. 1 is a diagram conceptually illustrating an example a gas barrier film of the present invention.

FIG. 2A and FIG. 2B are diagrams conceptually illustrating another example of the gas barrier film of the present invention.

FIG. 3 is a diagram conceptually illustrating still another example of the gas barrier film of the present invention.

FIG. 4A and FIG. 4B are plan views conceptually illustrating an example of a gas barrier film of the related art, and FIG. 4C is a plan view conceptually illustrating an example of the gas barrier film of the present invention.

FIG. 5A is a diagram conceptually illustrating an example of the gas barrier film of the related art, and FIG. 5B is a diagram conceptually illustrating an example of the gas barrier film of the present invention.

### DESCRIPTION OF THE PREFERRED EMBODIMENTS

Hereinafter, the gas barrier film, the electronic device, and the manufacturing method of a gas barrier film of the present invention will be described in detail described on the basis of preferred examples illustrated in the attached drawings.

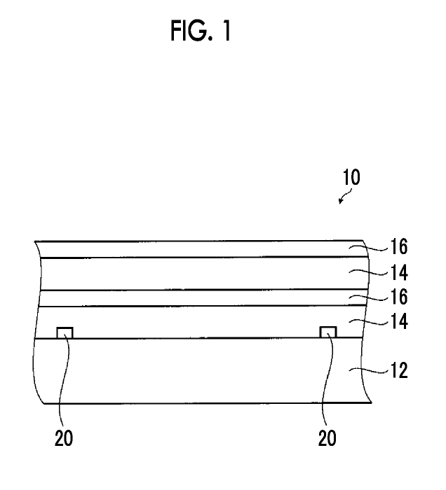

FIG. 1 conceptually illustrates an example of the gas barrier film of the present invention.

A Gas barrier film 10 illustrated in FIG. 1 is basically configured by including a support 12, a first organic layer 14 formed on a front surface of the support 12, a first inorganic layer 16 formed on a front surface of the organic layer 14, a second organic layer 14 formed on a front surface of the first inorganic layer 16, and a second inorganic layer 16 formed on a front surface of the second organic layer 14. In addition, an identification mark 20 is formed on the front surface of the support 12.

The organic layer 14 formed on an underlayer of the inorganic layer 16 acts as an undercoat layer for properly forming the inorganic layer 16, and this will be described below in detail. That is, the gas barrier film 10 illustrated in FIG. 1 includes two combinations of the organic layer 14 which becomes a base substrate, and the inorganic layer 16 formed on the organic layer 14.

Furthermore, the gas barrier film of the present invention is not limited to such a configuration, and can have various configurations insofar as the gas barrier film has an organic and inorganic laminated structure in which the organic layer 14 and the inorganic layer 16 are alternately formed.

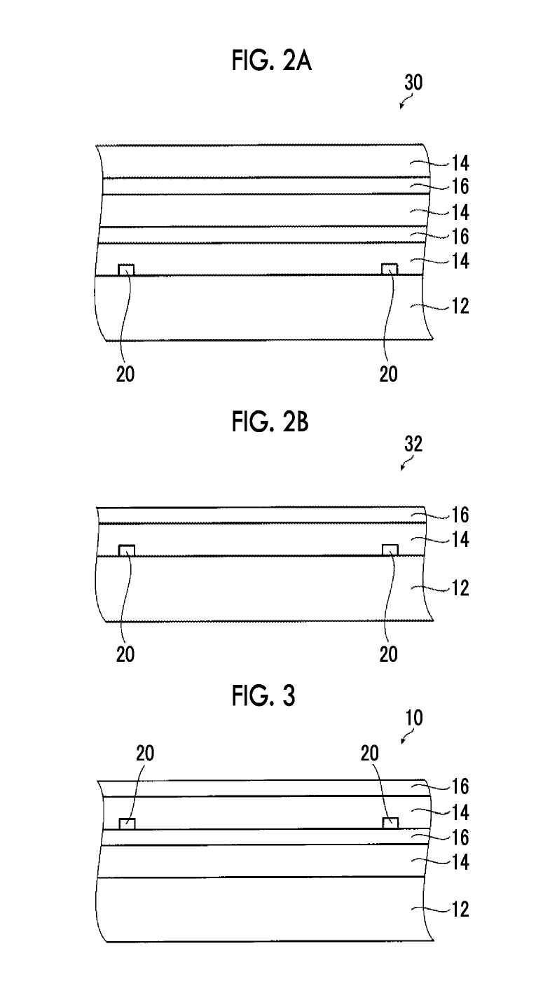

For example, a third organic layer 14 may be provided on the uppermost layer, as with a gas barrier film 30 conceptually illustrated in FIG. 2A. In this case, the organic layer 14 on the uppermost layer acts as a protective layer for protecting the inorganic layer 16.

Alternatively, the gas barrier film may have a configuration including only one combination of the inorganic layer 16 and the organic layer 14 which becomes the base substrate, as with a gas barrier film 32 conceptually illustrated in FIG. 2B. Alternatively, the gas barrier film may have a configuration including three or more combinations of the inorganic layer 16 and the organic layer 14 which becomes the base substrate.

Further, the gas barrier film may have a configuration in which the inorganic layer 16 is formed on the support 12, and one or more combinations of the inorganic layer 16 and the organic layer 14 which becomes the base substrate are provided on the inorganic layer 16 formed on the support 12. The organic layer 14 is basically formed by a coating method, and in a case where a composition forming the organic layer 14 contains a component dissolving the support 12, the support 12 can be protected by such a configuration.

In the gas barrier film 10, various known sheet-like materials which are used as supports not only in the gas barrier film having the organic and inorganic laminated structure, but also various gas barrier films or various laminated gas barrier films, can be used as the support 12.

Specifically, films formed of various resin materials (polymer materials) such as polyethylene terephthalate (PET), polyethylene naphthalate (PEN), polyethylene, polypropylene, polystyrene, polyamide, polyvinyl chloride, polycarbonate, polyacrylonitrile, polyimide, polyacrylate, and polymethacrylate are preferably exemplified as the support 12.

In addition, in the present invention, a support in which a layer (a film) for enabling various function to be obtained, such as a protective layer, an adhesive layer, a light reflecting layer, an antireflection layer, a light shielding layer, a flattening layer, a buffer layer, and a stress relaxation layer, is formed on a front surface of such a resin material film, may be used as the support 12.

In the gas barrier film 10 illustrated in FIG. 1 (FIG. 2A and FIG. 2B), the identification mark 20 is formed on the front surface of the support 12, that is, on the forming surface of the organic layer 14. The identification mark 20 is used for performing positioning or the like in a case of forming a pattern of an electronic device or the like on a front surface or a back surface of the gas barrier film 10, in a case of laminating other base materials or the like on the front surface or the back surface of the gas barrier film 10, and the like.

The identification mark 20 will be described below in detail.

Furthermore, in this example, a front side of the gas barrier film 10 is a side on which the organic layer and the inorganic layer are formed, and a back side of the gas barrier film 10 is a side on which the organic layer and the inorganic layer are not formed.

The gas barrier film 10 includes two organic layers 14. As illustrated, the organic layer 14 formed under the inorganic layer 16 functions as an undercoat layer for properly forming the inorganic layer 16 exhibiting the gas barrier properties.

By including such an organic layer 14 which becomes the undercoat layer, it is possible to embed the irregularity of the front surface of the support 12, foreign substances attached onto the front surface of the support 12, and the like in the organic layer 14, and to set a deposition surface of the inorganic layer 16 to be in a state suitable for forming the inorganic layer 16. Accordingly, it is possible to eliminate a region to which an inorganic compound which becomes the inorganic layer 16 is hardly attached, such as a dark portion due to the irregularity or the foreign substances on the front surface of the support 12, and to form a proper inorganic layer 16 on the entire front surface of the substrate without any gap.

Furthermore, as with the gas barrier film 30 illustrated in FIG. 2A, the organic layer 14 formed on the front surface (the outermost layer) of the gas barrier film acts as a protective layer (an overcoat layer) for protecting the inorganic layer 16, as described above.

The organic layer 14 is a layer formed of an organic compound, and is basically obtained by polymerizing a monomer, an oligomer, or the like. A forming material of the organic layer 14 is not limited, and various known organic compounds can be used.

Specifically, films of a thermoplastic resin such as polyester, an acrylic resin, a methacrylic resin, a methacrylic acid-maleic acid copolymer, polystyrene, a transparent fluorine resin, polyimide, fluorinated polyimide, polyamide, polyamide imide, polyether imide, cellulose acylate, polyurethane, polyether ether ketone, polycarbonate, alicyclic polyolefin, polyarylate, polyether sulfone, polysulfone, fluorene ring denatured polycarbonate, alicyclic denatured polycarbonate, fluorene ring denatured polyester, and an acrylic compound, or polysiloxane, and other organic silicon compounds are preferably exemplified. A plurality of such materials may be used together.

Among them, the organic layer 14 configured of a polymeric substance of a radical polymerizable compound and/or a cationic polymerizable compound having an ether group in a functional group is preferable from the viewpoint of a glass transition temperature, an excellent hardness, or the like.

Among them, an acrylic resin or a methacrylic resin containing a polymer of a monomer, an oligomer, or the like of acrylate and/or methacrylate as a main component is particularly preferably exemplified as the organic layer 14, from the viewpoint of a low refractive index, high transparency, excellent optical properties, and the like, in addition to the glass transition temperature or the hardness.

Among them, an acrylic resin or a methacrylic resin containing a polymer of a monomer, an oligomer, or the like of difunctional or higher, in particular, trifunctional or higher acrylate and/or methacrylate as a main component, such as dipropylene glycol di(meth)acrylate (DPGDA), trimethylol propane tri(meth)acrylate (TMPTA), and dipentaerythritol hexa(meth)acrylate (DPHA) is particularly preferably exemplified. In addition, it is also preferable that a plurality of such acrylic resins or methacrylic resins are used.

Furthermore, the organic layer 14 may contain various components such as a solvent, a surfactant, a polymerization initiator, and a silane coupling agent in addition to such an organic compound which mainly forms the organic layer 14.

Here, it is preferable that the organic layer 14 does not contain a component dissolving the identification mark 20 described below.

The thickness of the organic layer 14 is not limited, and is preferably 500 to 5,000 nm.

By setting the thickness of the organic layer 14 to be greater than or equal to 500 nm, it is possible to embed the irregularity of the front surface of the support 12 and the foreign substances attached onto the front surface of the support 12 in the organic layer 14, and to flatten the front surface of the organic layer 14, that is, the deposition surface of the inorganic layer 16.

In addition, by setting the thickness of the organic layer 14 to be less than or equal to 5,000 nm, it is possible to preferably suppress the occurrence of problems such as the cracking of the organic layer 14 or the curling of the gas barrier film 10, which are caused in a case where the organic layer 14 is excessively thick.

In consideration of the circumstances described above, the thickness of the organic layer 14 is more preferably 1,000 to 3,000 nm.

Here, it is preferable that the organic layer 14 formed on a front surface of a layer on which the identification mark 20 is formed, in other words, a step on the forming surface due to the identification mark 20 is embedded in the organic layer 14 covering the identification mark 20, and the front surface is flattened.

Further, in order to form the flat organic layer 14, it is preferable that the organic layer 14 covering the identification mark 20 has a thickness two or more times the thickness of the identification mark 20. That is, in the gas barrier film 10 illustrated in FIG. 1, it is preferable that the organic layer 14 formed on the front surface of the support 12 has a thickness two or more times the thickness of the identification mark 20.

By setting the thickness of the organic layer 14 covering the identification mark 20 to be two or more times the thickness of the identification mark 20, it is possible to absorb the irregularity of the support 12 due to the identification mark 20, and to flatten the front surface of the organic layer 14. Accordingly, it is possible to properly form the inorganic layer 16 on the organic layer 14 covering the identification mark 20.

Specifically, the thickness of the organic layer 14 covering the identification mark 20 is preferably greater than or equal to 500 nm, is more preferably greater than or equal to 1,000 nm, and is even more preferably greater than or equal to 2,000 nm.

The thickness of the identification mark 20 is preferably less than or equal to 200 nm, and this will be described below. For this reason, by setting the thickness of the organic layer 14 covering the identification mark 20 to be greater than or equal to 500 nm, it is possible to more preferably absorb the irregularity of the support 12 due to the identification mark 20, and to flatten the front surface of the organic layer 14.

Furthermore, in the present invention, the front surface of the organic layer 14 covering the identification mark 20 being flattened indicates that a difference between the heights of the highest position and the lowest position on the front surface of the organic layer 14 is less than or equal to 100 nm in a radius range of 1 mm centered on the identification mark 20, as an example.

In addition, the radius range of 1 mm centered on the identification mark 20 indicates the inside of a circle which has a radius of 1 mm and has the same center as that of a circle inscribed in the identification mark 20.

Such an organic layer 14 having a flat front surface can be formed by a so-called coating method, in which a layer formed of an organic compound is formed by using a liquid composition formed by dissolving a polymerizable compound such as TMPTA described above in a solvent.

In the present invention, in a case of including a plurality of organic layers 14 as with the gas barrier film 10 illustrated in FIG. 1, the thicknesses of the respective organic layers 14 may be identical to each other or different from each other. In addition, forming materials of the respective organic layers 14 may be identical to each other or different from each other.

The inorganic layer 16 is a layer formed of an inorganic compound.

The gas barrier properties of the gas barrier film 10 are mainly exhibited by the inorganic layer 16.

A forming material of the inorganic layer 16 is not limited, and various layers formed of an inorganic compound exhibiting the gas barrier properties can be used.

Specifically, films formed of inorganic compounds such as a metal oxide such as aluminum oxide, magnesium oxide, tantalum oxide, zirconium oxide, titanium oxide, and indium tin oxide (ITO); a metal nitride such as aluminum nitride; a metal carbide such as aluminum carbide; a silicon oxide such as silicon oxide, silicon oxynitride, silicon oxycarbide, and silicon oxynitrocarbide; a silicon nitride such as silicon nitride and silicon nitrocarbide; a silicon carbide such as silicon carbide; a hydride thereof; a mixture of two or more types thereof; and a hydrogen-containing substance thereof are preferably exemplified.

In particular, silicon nitride, silicon oxide, silicon oxynitride, and aluminum oxide are preferably used from the viewpoint of high transparency and of enabling excellent gas barrier properties to be exhibited. Among then, silicon nitride is particularly preferably used from the viewpoint of high transparency in addition to excellent gas barrier properties.

In a film thickness of the inorganic layer 16, a thickness at which intended gas barrier properties can be exhibited, may be suitably determined according to the forming material. Furthermore, according to studies of the present inventors, the thickness of the inorganic layer 16 is preferably 10 to 200 nm.

By setting the thickness of the inorganic layer 16 to be greater than or equal to 10 nm, it is possible to form the inorganic layer 16 stably exhibiting, sufficient gas barrier performance. In addition, the inorganic layer 16 is generally brittle, and in a case where the inorganic layer 16 is excessively thick, there is a possibility that a crack or a fracture, peeling off, and the like occur, and thus, it is possible to prevent the occurrence of the crack by setting the thickness of the inorganic layer 16 to be less than or equal to 200 nm.

In addition, in consideration of such circumstances, the thickness of the inorganic layer 16 is preferably 15 to 100 nm, and is particularly preferably 20 to 75 nm.

Furthermore, in the present invention, in a case of including a plurality of inorganic layers 16 as with the gas barrier film 10 illustrated in FIG. 1 or the gas barrier film 30 illustrated in FIG. 2A, the thicknesses of the respective inorganic layers 16 may be identical to each other or different from each other. In addition, similarly, in a case where the gas barrier film includes a plurality of inorganic layers 16, forming materials of the respective inorganic layers 16 may be identical to each other or different from each other.

The gas barrier film 10 includes the identification mark 20 on the front surface of the support 12.

In the gas barrier film 10, the identification mark 20 is used for various applications in the manufacturing of an electronic device using the gas barrier film 10 as a substrate, and the like.

The identification mark 20 can be used for controlling the meandering of the gas barrier film 10, and the like at the time of handling a long gas barrier film 10 in a longitudinal direction in a roll to roll manner or the like, as an example. In the following description, “roll to roll” will also referred to “R to R”.

In addition, the identification mark 20 can also be used for controlling tension or deformation in a case where the gas barrier film 10 is deformed, such as a case where the tension is applied.

In addition, in the manufacturing of the electronic device using the gas barrier film 10 as the substrate, the identification mark 20 can also be used for positioning a forming position of the element and the like, for measuring or correcting the deformation of the gas barrier film 10, for measuring or controlling a gap between the gas barrier film 10 and a forming device of a pattern or the like, and the like, at the time of forming one type or a plurality of types of patterns, and the like of an electronic element and the like constituting the electronic device.

In addition, the identification mark 20 can also be used for performing positioning, timing matching, controlling of the gap, and the like in a case of performing bonding between the gas barrier films 10, bonding between the gas barrier film 10 and other base materials, and the like.

Further, the identification mark 20 can also be used for acquiring manufacturing information of the gas barrier film 10 or position information of the long gas barrier film 10 in the longitudinal direction, and the like.

That is, in the gas barrier film 10 of the present invention, the identification mark 20 may be used for positioning each member or controlling the handling, for providing various information items, and the like, or may be used as a so-called global alignment mark which becomes a reference of a position in which the electronic device or the like is manufactured.

In the gas barrier film 10 of the present invention, the identification mark 20 which is used in such applications, is formed on the forming surface of the organic layer 14. In other words, in the gas barrier film 10 of the present invention, the organic layer 14 is formed on the forming surface of the identification mark 20. That is, the identification mark 20 is covered with the organic layer 14.

As with the gas barrier film 10 illustrated in FIG. 1, it is preferable that the identification mark 20 and the organic layer 14 are formed on the support 12.

The present invention has such a configuration, and thus, in the gas barrier film having the organic and inorganic laminated structure, a gas barrier film, which can be preferably used as a substrate of an organic EL device or the like, is realized.

As described above, the gas barrier film having the organic and inorganic laminated structure, in which the inorganic layer 16 exhibiting the gas barrier properties and the organic layer 14 which becomes the undercoat layer of the inorganic layer are alternately formed, is known as a gas barrier film having high gas barrier properties. In addition, it is also considered that the gas barrier film having the organic and inorganic laminated structure is used as the substrate of the electronic device such as the organic EL device.

In order to use the gas barrier film having the organic and inorganic laminated structure as the substrate of the electronic device, it is necessary to form the identification mark such as an alignment mark for performing the positioning of the pattern of the electronic element constituting the electronic device.

In a case where the identification mark is formed on the gas barrier film having the organic and inorganic laminated structure, in general, it is considered that the identification mark is formed on the front surface or the back surface. That is, according to the gas barrier film 10 illustrated in FIG. 1, it is considered that the identification mark is formed on the front surface of the inorganic layer 16 on the outermost layer or the back surface of the support 12.

However, according to the studies of the present inventors, in a case where the identification mark 20 is formed on the front surface or the back surface of the gas barrier film 10, in a manufacturing step of the electronic device or physical contact at the time of performing handling, a step including heating or a chemical liquid step in the manufacturing of the electronic device, and the like, a local force or a stress is applied onto the inorganic layer 16 due to the irregularity which is caused by the identification mark 20, and thus, there is a possibility that the inorganic layer 16 is damaged.

In the gas barrier film 10 having the organic and inorganic laminated structure, the inorganic layer 16 exhibits the gas barrier properties. Accordingly, in a case where the inorganic layer 16 is damaged, the gas barrier properties decrease.

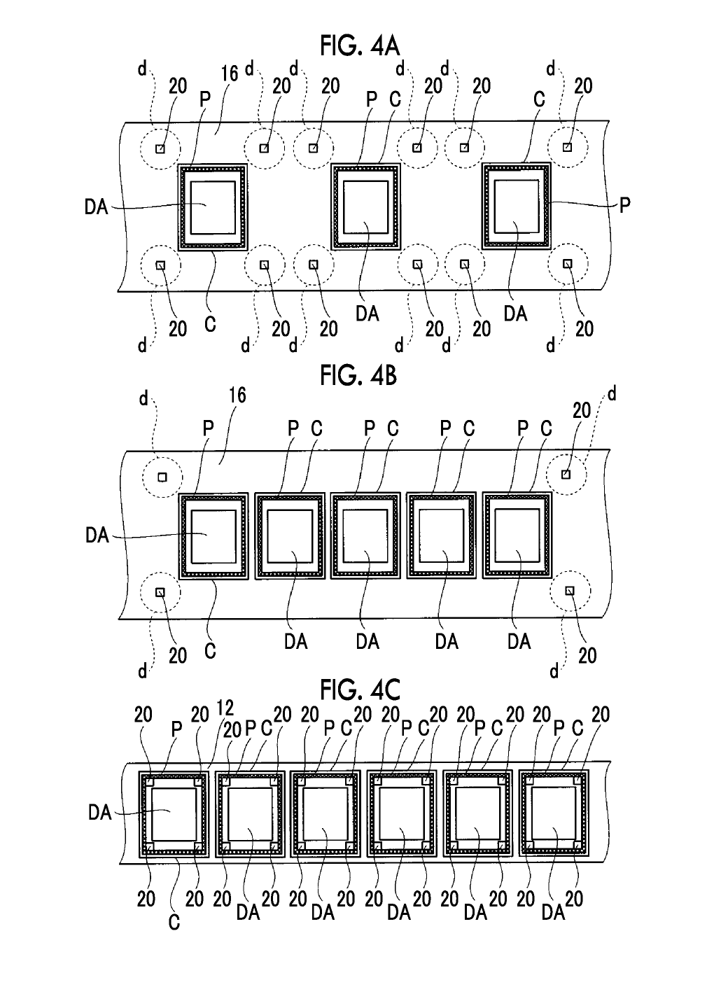

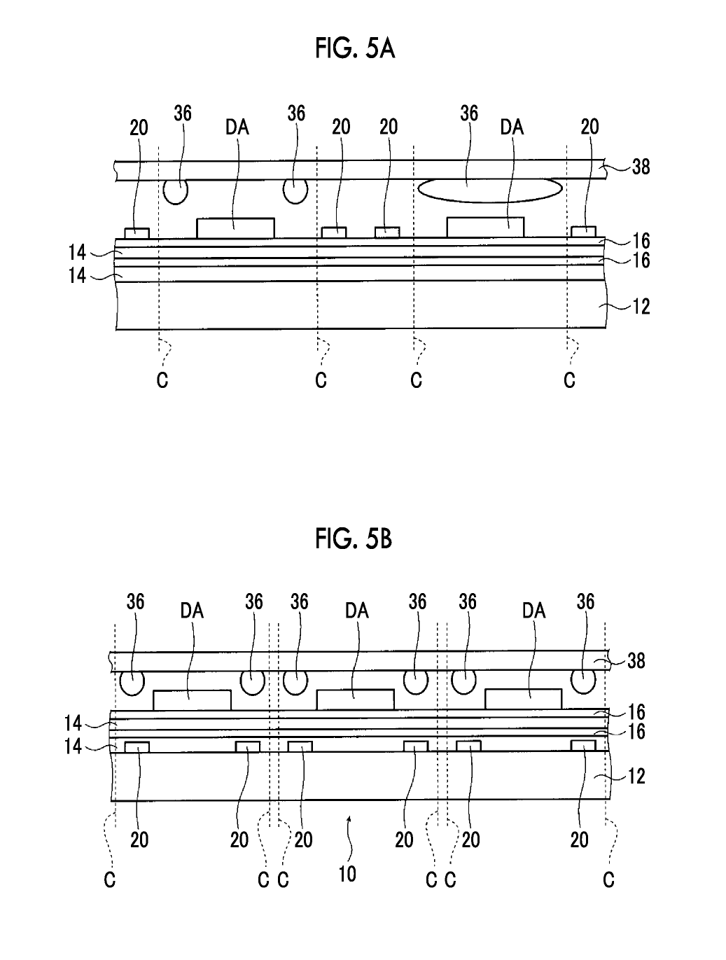

In addition, as conceptually illustrated in FIG. 4A and FIG. 5A, in a case where the gas barrier film 10 is used as the substrate of the electronic device, in order to avoid the influence of the decrease in the gas barrier properties due to the damage of the inorganic layer 16, it is considered that a margin space is disposed between the identification mark 20 and a forming region DA of the electronic device or a sealing end portion P. That is, it is considered that a forming interval of the electronic devices widens, and an interval between the forming region DA of the electronic device or the sealing end portion P and the identification mark 20 widens, and thus, the forming region DA or the sealing, end portion P is removed from a region d indicated by a broken line, in which there is a concern that the inorganic layer 16 is damaged due to the identification mark 20.

However, in such a case, the yield of the electronic device, that is, a surface utilization efficiency deteriorates, and the manufacturing costs of the electronic device increase.

In order to make the yield of the electronic device excellent, as conceptually illustrated in FIG. 4B, it is also considered that the number of identification marks 20 is reduced.

However, in a case where the number of identification marks 20 is reduced as described above, the positioning accuracy between the respective patterns configuring the electronic device or the bonding position accuracy of the film or the like decreases.

Furthermore, in FIG. 4A to FIG. 4C, and FIG. 5A and FIG. 5B, a reference numeral of C is a cutting portion of each of the electronic devices.

In addition, in FIG. 5A and FIG. 5B, a reference numeral of 36 is a sealing material, and a reference numeral of 38 is a sealing film. Further, in FIG. 5A, a sealing material 36 of an electronic device on a left side exemplifies frame sealing, and a sealing material 36 of an electronic device on a right side exemplifies overall sealing.

In a case where the identification mark 20 is formed on the front surface or the back surface of the gas barrier film 10, it is considered that the subsequent step is performed such that the inorganic layer 16 is not damaged. However, in this case, in order to perform the subsequent step such that the inorganic layer 16 is not damaged, there is also a possibility that the production costs of the electronic device or the like increase according to various steps or restriction of equipment.

Further, there are many cases where the gas barrier film 10 is manufactured in the R to R manner, and there are many cases where the R to R manner is used in the manufacturing step of the electronic device using the gas barrier film 10 manufactured in the R to R manner, and the like. Here, in a case where the identification mark 20 is formed on the front surface or the back surface, only the forming position of the identification mark is bulged in a width direction due to the irregularity which is caused by the identification mark at the time of winding the gas barrier film 10, and thus, it is not possible to evenly wind the gas barrier film 10.

In contrast, in the gas barrier film 10 of the present invention, the organic layer 14 is formed by covering the identification mark 20 in the gas barrier film having the organic and inorganic laminated structure.

Accordingly, in the gas barrier film 10 of the present invention, it is possible to embed the irregularity due to the identification mark 20 in the organic layer 14. For this reason, in the physical contact, and the step including thermal heating or the chemical liquid step, it is possible to prevent the local force or the stress from being applied onto the inorganic layer 16, and to prevent the inorganic layer 16 from being damaged. In addition, it is possible to evenly wind the gas barrier film 10 even at the time of winding the gas barrier film 10 in the R to R manner.

Further, in the gas barrier film 10 of the present invention, the forming position of the identification mark 20 or the flatness and the gas barrier properties in the peripheral portion of the forming position are ensured. For this reason, as conceptually illustrated in FIG. 4C and FIG. 5B, it is possible to minimize the interval between the forming region DA of the electronic device or the sealing end portion P and the identification mark 20, at the time of using the gas barrier film 10 as the substrate of the electronic device such as the organic EL device. As a result thereof, it is possible to improve the yield of the electronic device, and to reduce the manufacturing costs of the electronic device. Further, it is not necessary to reduce the number of identification marks 20, and thus, it is possible to perform the positioning between the respective patterns configuring the electronic device or the bonding of the film or the like with high accuracy. In addition, it is also possible to prevent a harmful influence on the electronic device due to moisture, which is caused by the damage of the inorganic layer 16.

The forming position of the identification mark 20 in a laminating direction of the organic layer 14 and the inorganic layer 16 is not limited to the front surface of the support 12 illustrated in FIG. 1.

That is, the identification mark 20 can be formed on each layer in the laminating direction, insofar as the identification mark 20 is on the forming surface of the organic layer 14. For example, as conceptually illustrated in FIG. 3, the identification mark 20 and the second organic layer 14 may be formed on the front surface of the first inorganic layer 16. Alternatively, the identification mark 20 may be formed on a plurality of different layers.

Here, in consideration of the easiness of forming the identification mark 20, the damage prevention of the inorganic layer 16, and the like, as illustrated in FIG. 1, it is preferable that the identification mark 20 is formed only on the support 12, and the organic layer 14 is formed on the front surface of the support 12.

The forming position of the identification mark 20, the number of identification marks 20, and the size of the identification mark 20 in a plane direction of the gas barrier film 10 may be suitably set according to the application of the gas barrier film 10, the size of the gas barrier film 10, a slit width in the subsequent step, the layout of the electronic device, the application of the identification mark 20, the shape of the identification mark 20, the performance of the identification mark detector, and the like. Furthermore, in a case of using the R to R manner, the size of the gas barrier film 10 is the width of the gas barrier film 10.

In the shape of the identification mark 20, various shapes such as a symbol, a numeral, a character, a patterned picture, and an unpatterned picture can be used according to the application of the identification mark 20, and the like.

In a case where the identification mark 20 is positioned and is used as a so-called alignment mark, a cross, a register mark used in printing or the like, a polygon such as a quadrangle, a circle, an ellipse, or a dot, a moire interference pattern, and the like are exemplified as an example.

In a case where the identification mark 20 is used as a mark for measuring a deformation amount of the film, a cross, a register mark used in printing or the like, a polygon such as a quadrangle, a circle, an ellipse, or a dot, a moire interference pattern, and the like are exemplified.

In a case where the identification mark 20 is used for controlling the gap, light reflective regions having various shapes, a moire pattern, and the like are exemplified.

Further, in a case where the identification mark is sued as various information sources of the manufacturing information, step condition information, and longitudinal position direction, a character, a numeral, various symbols, and the like are exemplified.

Various known materials which are used in an alignment mark and the like can be used as a forming material of the identification mark 20. Accordingly, various known light absorbing or light reflective materials or various known transparent.semi-transparent materials, which are used in various alignment marks and the like, can be used in the forming material of the identification mark 20.

Various metal materials such as chromium or aluminum, various inks, and the like are exemplified as the light absorbing or light reflective material, as an example. In addition, a transparent conductive material such as indium tin oxide (ITO) or zinc oxide, a dielectric material such as silicon oxide, aluminum oxide, and silicon nitride, and the like are exemplified as the transparent.semi-transparent material.

Furthermore, the identification mark 20, in general, is formed of a material which can be detected by visible light. However, as necessary, the identification mark 20 may be formed of a material which can be detected only by light at a specific wavelength, such as a material which can be detected only by an infrared ray and a material which can be detected only by an ultraviolet ray.

The thickness of the identification mark 20 may be suitably set according to the thickness of the organic layer 14 covering the identification mark 20, the thickness of the gas barrier film 10, the position of the identification mark 20 in the laminating direction, the position of the identification mark 20 in the plane direction of the gas barrier film 10, and the like.

Here, as described above, it is preferable that the thickness of the identification mark 20 is less than or equal to ½ of the organic layer 14. Accordingly, it is possible to absorb the irregularity of the support 12 due to the identification mark 20, and to flatten the front surface of the organic layer 14 covering the identification mark 20.

Specifically, the thickness of the identification mark 20 is preferably less than or equal to 200 nm, is more preferably less than or equal to 100 nm, and is even more preferably less than or equal to 50 nm. As described above, the thickness of the organic layer 14 covering the identification mark 20 is preferably greater than or equal to 500 nm. For this reason, by setting the thickness of the identification mark 20 to be less than or equal to 200 nm, it is possible to absorb the irregularity of the support 12 due to the identification mark 20, and to more preferably flatten the front surface of the organic layer 14 covering the identification mark 20.

In addition, it is preferable that the thickness of the identification mark 20 is set in consideration of the forming material of the identification mark 20. In a case where the forming material of the identification mark 20 is the light absorbing or light reflective material such as a metal, the thickness of the identification mark 20 is preferably greater than or equal to 30 nm, as an example. In addition, in a case where the forming material of the identification mark 20 is the transparent.semi-transparent material such as a dielectric material, the thickness of the identification mark 20 is preferably greater than or equal to 150 nm.

Setting the thickness of the identification mark 20 according to the forming material of the identification mark is preferable from the viewpoint of enabling the identification mark 20 to be reliably detected.

Further, the identification mark is not limited to a convex shape as illustrated, and may have a concave shape.

In a case where the identification mark has a concave shape, the thickness of the identification mark 20 described above is substituted with the depth of the identification mark. In addition, the concave identification mark may be tinted with a metal material or an ink.

The electronic device of the present invention is formed by forming the electronic element constituting the electronic device, such as an organic EL element constituting an organic EL device or a photoelectric conversion element constituting a solar battery, on the front surface or the back surface, or both surfaces of the gas barrier film 10 (30 or 32) of the present invention.

In the electronic device of the present invention, all of various known electronic devices can be used. Specifically, an organic EL device, a solar battery, electronic paper, an electrochromic device, a touch panel, and the like are exemplified.

Such electronic devices may be prepared by a known method.

Furthermore, the gas barrier film 10 of the present invention includes the identification mark 20, and thus, it is possible to perform the positioning of the forming position of the pattern configuring the electronic element or the controlling of the meandering of the gas barrier film 10 in the R to R manner by using the identification mark 20. Accordingly, according to the present invention, it is possible to stably obtain a proper electronic device.

Hereinafter, an example of a manufacturing method of the gas barrier film 10 illustrated in FIG. 1 will be described, and thus, the manufacturing method of the gas barrier film of the present invention will be described.

Furthermore, in the manufacturing method of the present invention, the gas barrier film 10 may be manufactured in the R to R manner, or gas barrier film 10 may be manufactured by using a cut sheet-like support 12 in a so-called sheet feeding manner (a batch feeding manner).

As is well known, the R to R manner is a manufacturing method in which a material for film formation is fed from a material roll around which a long material for film formation is wound into the shape of a roll, film formation is performed while handling the material for film formation in the longitudinal direction, and a material for film formation of a film forming agent is wound again into the shape of a roll. In the manufacturing method of the present invention, the R to R manner is preferably used in consideration of productivity.

Furthermore, the manufacturing method described below is basically similar in the R to R manner and in the sheet feeding manner.

First, the identification mark 20 is formed in a predetermined position on one surface of the support 12.

The identification mark 20 may be formed by a known method according to the forming material.

For example, in a case where the identification mark 20 is formed of a metal, a forming method in which a metal film is formed by using a mask, a forming method in which a metal film is formed on the support 12, and then, is etched by using photolithography or the like, a forming method in which a metal film is formed by printing using a metal paste or the like, and the like are exemplified. Furthermore, the metal film may be formed by a known vapor phase deposition method such as vacuum vapor deposition, sputtering, plasma CVD, and the like.

In addition, in a case where the identification mark 20 is formed of an ink, the identification mark 20 may be formed by a known printing method such as relief printing, gravure printing, screen printing, and ink jet.

Next, the organic layer 14 is formed on the surface of the support 12 on which the identification mark 20 is formed.

The organic layer 14 may be formed by a known method according to the organic layer 14 to be formed. The organic layer 14 is formed by a so-called coating method in which a composition containing an organic solvent, a polymerizable compound (a monomer, a dimer, a trimer, an oligomer, a polymer, and the like) which becomes the organic layer 14, a surfactant, a silane coupling agent, and the like is prepared, this coating liquid is applied and dried, and as necessary, the polymerizable compound is polymerized (crosslinked) by ultraviolet ray irradiation or the like, as an example.

Here, as described above, it is preferable that the organic layer 14 does not contain a component dissolving the identification mark 20. Accordingly, in a case where the organic layer 14 is formed by a coating method, it is preferable that the composition which becomes the organic layer 14 is prepared by using a solvent not dissolving the identification mark 20. In addition, it is preferable that the composition which becomes the organic layer 14 does not contain the component dissolving the identification mark 20 in addition to the solvent.

Next, the inorganic layer 16 is formed on the front surface of the organic layer 14.

The inorganic layer 16 may also be formed by a known method according to the inorganic layer 16 to be formed. The inorganic layer 16 is formed by plasma CVD such as CCP-CVD or ICP-CVD, sputtering such as magnetron sputtering or reactive sputtering, and a vapor phase film forming method such as vacuum vapor deposition, as an example.

Next, the second organic layer 14 is formed on the front surface of the inorganic layer 16 as described above. Furthermore, the second organic layer 14 may be formed by using a composition containing a solvent dissolving the identification mark, and the like.

Further, the second inorganic layer 16 is formed on the front surface of the second organic layer 14 as described above, and thus, the gas barrier film 10 is prepared.

The formation of the organic layer 14 and the inorganic layer 16 is further repeated, and thus, a gas barrier film including three of more combinations of the organic layer 14 which is the base substrate and the inorganic layer 16. In addition, the organic layer 14 for protecting the inorganic layer 16 may be similarly formed on the uppermost layer.

Furthermore, in a case where the gas barrier film 10 illustrated in FIG. 3 is prepared, the first organic layer 14 and the inorganic layer 16 are formed without forming the identification mark 20 on the front surface of the support 12, and the identification mark 20 is formed on the front surface of the first inorganic layer 16 as described above.

Next, the second organic layer 14 and the inorganic layer 16 may be formed on the inorganic layer 16 on which the identification mark 20 is formed as described above.

As described above, the gas barrier film, the electronic device, and the manufacturing method of the gas barrier film of the present invention have been described in detail, but the present invention is not limited to the examples described above, and various improvements or modifications may be obviously performed within a range not departing from the gist of the present invention.

### EXAMPLES

Hereinafter, the present invention will be described in detail with reference to specific examples of the present invention.

### Example 1

The gas barrier film 10 including the identification mark 20, the first organic layer 14, the first inorganic layer 16, the second organic layer 14, and the second inorganic layer 16 on the support 12 as illustrated in FIG. 1 was prepared.

A PET film having a width of 1,000 mm, a thickness of 100 μm, and a length of 100 m (COSMOSHINE A4300 manufactured by TOYOBO CO., LTD.) was used as the support 12.

### Formation of Identification Mark 20

A roll of the support 12 was loaded in a predetermined position of a general film forming device using an R to R manner in which film formation was performed by vacuum vapor deposition, and the support 12 was inserted into a predetermined handling path. By using such a device, an aluminum film having a thickness of 200 nm was formed on the overall support 12, and was wound into the shape of a roll.

Next, the roll of the support 12 on which the aluminum film was formed was loaded in a predetermined position of a general device using an R to R manner in which a coating and drying unit of a resist was provided, and the support 12 was inserted into a predetermined handling path. By using such a device, a resist film having a thickness of 500 nm was formed on the aluminum film formed on the support 12, and was wound into the shape of a roll.

Further, the roll of the support 12 on which the resist film was formed was loaded in a predetermined position of a general device using an R to R manner in which a contact exposing unit, a developing unit, a rinsing unit, an etching unit, a washing unit, and a drying unit were provided, and a pattern was formed by photolithography, and the support 12 was inserted into a predetermined handling path. By using such a device, the identification mark 20 which was formed of aluminum and had a thickness of 200 nm was formed on the front surface of the support 12, and was wound into the shape of a roll.

The identification mark 20 had a cross shape, a line width of 50 μm, and vertical and horizontal lengths of 250 μm.

The identification mark 20 was formed at an interval of 20 cm in a width direction of the support 12 and at an interval of 30 cm in a longitudinal direction of the support 12.

### Formation of First Organic Layer 14

TMPTA (manufactured by DAICEL-ALLNEX LTD.) and a photopolymerization initiator (ESACURE KTO46 manufactured by Lamberti S.p.A.) were weighed to be 95:5 as a mass ratio, and were dissolved in MEK, and thus, a composition for forming the organic layer 14 of which the concentration of solid contents was 15 mass % was prepared.

A predetermined position of a coating unit in a general film forming device using an R to R manner in which a coating unit using a die coater, a drying unit using hot air, and a curing unit using ultraviolet ray irradiation were provided, was filled with this coating liquid. In addition, the roll around which the support 12 having the identification mark 20 formed thereon was wound was loaded in a predetermined position of the film forming device, and was inserted into a predetermined handling path of the support 12.

In the film forming device, the support 12 on which the identification mark 20 was formed was coated with the coating liquid by the die coater while being handled in the longitudinal direction, and passed through the drying unit at 50° C. for 3 minutes. After that, ultraviolet ray irradiation (integrated irradiation dose of approximately 600 mJ/cm²) was performed, and then, curing was performed by UV curing, and winding was performed, and thus, the organic layer 14 was formed on the surface of the support 12 on which the identification mark 20 was formed, and was wound into the shape of a roll. The thickness of the organic layer 14 was 2,000 nm.

### Formation of First Inorganic Layer 16

The roll of the support 12 on which the organic layer 14 was formed loaded in a predetermined position of a general CVD film forming device using an R to R manner in which film formation was performed by CCP-CVD (capacitive coupling plasma CVD), and the support 12 was inserted into a predetermined handling path.

In the CVD film forming device, a silicon nitride film was formed on the organic layer 14 as the inorganic layer 16 while handling the support 12 on which the organic layer 14 was formed in the longitudinal direction, and was wound into the shape of a roll.

Silane gas (a flow rate of 160 sccm), ammonia gas (a flow rate of 370 sccm), hydrogen gas (a flow rate of 590 sccm), and nitrogen gas (a flow rate of 240 sccm) were used as raw material gas. High frequency power having a frequency of 13.56 MHz was used as power, and plasma excitation electric power was set to 800 W. A film formation pressure was set to 40 Pa. A film thickness of the inorganic layer 16 was 30 nm.

### Formation of Second Organic Layer 14 and Inorganic Layer 16

The second organic layer 14 was formed on the first inorganic layer 16 as described above except that the thickness was changed, and the second inorganic layer was formed on the second organic layer 14 as described above. A film thickness of the second organic layer 14 was 1,000 nm, and a film thickness of the second inorganic layer was 30 nm.

### Comparative Example 1

A gas barrier film in which two organic layers 14 and two inorganic layer 16 were alternately formed was prepared by the same method as that in Example 1 except that the identification mark 20 was not formed on the front surface of the support 12.

### Comparative Example 2

A gas barrier film in which two organic layers 14 and two inorganic layers were alternately formed was prepared by the same method as that in Example 1 except that the identification mark 20 was not formed on the front surface of the support 12, and the identification mark 20 was formed on the front surface of the second (the outermost layer) inorganic layer 16 by the same method as that in Example 1.

### Gas Barrier Property Test

The moisture vapor permeability of the prepared gas barrier film was measured by a calcium method. Specifically, the moisture vapor permeability [g/(m²·day)] was measured by using a method described on pages 1435 to 1438 of SID Conference Record of the International Display Research Conference of G. NISATO, P. C. P. BOUTEN, P. J. SLIKKERVEER, et al.

As a result thereof, the moisture vapor permeability of the gas barrier film 10 of Example 1 was 6.2×10⁻⁶ g/(m²·day).

In addition, the moisture vapor permeability of the gas barrier film of Comparative Example 1 was 5.8×10⁻⁶ g/(m²·day).

Further, the moisture vapor permeability of the gas barrier film of Comparative Example 2 was 2.8×10⁻⁴ g/(m²·day).

That is, even though the gas barrier film 10 of the present invention includes the identification mark 20, the gas barrier film 10 of the present invention has the gas barrier properties equivalent to those of the gas barrier film of Comparative Example 1 having a general organic and inorganic laminated structure in which the identification mark 20 is not provided. In contrast, in the gas barrier film of Comparative Example 2 in which the identification mark 20 is formed on the front surface, it is considered that the inorganic layer 16 is damaged due to the identification mark 20, and the gas barrier properties decrease compared to the other two gas barrier films.

From the results described above, the effects of the present invention are obvious.

### EXPLANATION OF REFERENCES

10,30,32: gas barrier film

12: support

14: organic layer

16: inorganic layer

20: identification mark

36: sealing material

38: sealing film

What is claimed is:

1. A gas barrier film, comprising:
a support;
an organic and inorganic laminated structure which is formed on the support and has at least one organic layer and at least one inorganic layer, and in which the organic layer and the inorganic layer are alternately laminated; and
an identification mark formed on a forming surface of the at least one organic layer.

2. The gas barrier film according to claim 1,
wherein the identification mark and the organic layer are formed on a front surface of the support.

3. The gas barrier film according to claim 1,
wherein an organic layer formed on a forming surface of the identification mark has a flat front surface by absorbing irregularity due to the identification mark.

4. The gas barrier film according to claim 1,
wherein the organic layer formed on the forming surface of the identification mark has a thickness two or more times a thickness of the identification mark.

5. The gas barrier film according to claim 1,
wherein the thickness of the identification mark is less than or equal to 200 nm, and the thickness of the organic layer formed on the forming surface of the identification mark is greater than or equal to 500 nm.

6. An electronic device, comprising:
an electronic element constituting the electronic device, which is formed on the gas barrier film according to claim 1.

7. A manufacturing method of a gas barrier film, comprising:
forming an organic and inorganic laminated structure on a support, in which at least one organic layer and at least one inorganic layer are provided, and the organic layer and the inorganic layer are alternately laminated; and
forming an identification mark on a forming surface of the organic layer before forming the at least one organic layer.

8. The manufacturing method of a gas barrier film according to claim 7,
wherein the identification mark and the organic layer are formed on the support.

9. The manufacturing method of a gas barrier film according to claim 7,
wherein the organic layer is formed by a coating method using a composition containing a polymerizable compound.
